(19) United States
(12) Patent Application Publication
(10) Pub. No.: US 2018/0200672 A1
(43) Pub. Date: Jul. 19, 2018

(54) METHOD FOR SEPARATING MERCURY FROM FLUE GAS

(71) Applicant: VPC GmbH, Vetschau/Spreewald (DE)

(72) Inventors: Jan Schütze, Leipzig (DE); Ralf Paeslack, Vetschau (DE)

(73) Assignee: VPC GmbH, Vetschau/Spreewald (DE)

(21) Appl. No.: 15/746,445

(22) PCT Filed: Jul. 25, 2016
(86) PCT No.: PCT/DE2016/100333

§ 371 Date: Jan. 22, 2018

(30) Foreign Application Priority Data
Jul. 23, 2015 (DE) 10 2015 009 343.6

(51) Int. Cl. B01D 53/83; B01D 53/86; B01J 23/745; B01J 35/02; F23J 15/00

(52) U.S. Cl. CPC B01D 53/83; B01D 53/8665; B01J 23/745; B01J 35/023; F23J 2219/10; B01D 2257/602; B01D 2258/0283; B01D 2255/20738; F23J 2215/60; F23J 15/003

(57) ABSTRACT

The invention relates to a method for separating mercury (Hg) from furnace gases of combustion plants, wherein a catalytically active material having a mean grain diameter <35 μm is metered into the furnace gas, the elemental mercury in the furnace gases is oxidized, and resulting oxidized mercury is separated in the process using adsorption and absorption techniques in preexisting plant technology. The intensified formation of oxidized mercury is performed within a temperature range <500° C.

### TECHNICAL FIELD

The invention relates to a method for separating mercury (Hg) from flue gas of combustion plants, wherein elemental mercury in the flue gas is oxidized, and resulting oxidized mercury is separated during the treatment and filtering of the flue gas.

### BACKGROUND

Currently known methods of eliminating mercury from flue gas are aimed primarily at the separation of readily water-soluble and easily adsorbable oxidized mercury species. Elemental mercury species must also be decreased in many cases to comply with stricter mercury emission limits in the future. Up until now, only a few technologies have been available on the market.

Up until now, direct mercury (Hg) separation takes place from flue gases to filters or by binding of mercury in devices for desulfurization (mainly wet FGD). In those, the oxidized Hg (Hgox) is primarily separated due to its good water solubility. The separation of the elemental Hg species (Hgel) often causes problems. The conventional decrease in the Hgel species takes place on SCR-DeNOx catalysts, on which Hgel is converted to the Hgox species by oxidation reactions. Since such DeNOx catalysts are not available in all combustion plants, the Hgel species are emitted from such plants mostly undiminished.

There are only a few ways to purposefully promote this oxidation reaction besides the uncontrolled oxidation reaction of elemental mercury, which depends on the flue gas and plant conditions. The most widespread measure to date is the installation of a solid SCR-DeNOx catalyst, which catalyzes the oxidation reaction of elemental mercury along with the denitrification. Some catalyst manufacturers develop special, permanently installed Hg catalysts (for example EP 2 075 060 A1, EP 1 982 763 A1, EP 2 324 903 A1) for this purpose. However, in many combustion plants, it is not possible to integrate the SCR-DeNOx or permanently installed Hg oxidation catalysts without considerable changes, such as, for example, heating of the furnace gas, limited available space or increased pressure loss via the cleaning devices. The investment costs of SCR-DeNOx catalysts are also far higher than those of the novel method presented here.

Another option available for targeted Hg oxidation is the addition of halides for firing. In this case, the halides are released together with the fuel for firing in the temperature range >500° C. In particular, bromide additives (EP 1 386 655) achieve oxidation rates of >80% with moderate dosing amounts. In the literature, isolated cases of increased corrosion in the boiler and on plates of the heat exchangers are reported. Chloride additives require about ten times the dose for results comparable to bromide. Iodides are similarly effective to bromide but significantly more expensive.

Activated carbons are injected in the flue gas as the third technology, mainly used in plants in the USA (EP 2 260 940 A4). Adsorption or chemisorption mechanisms of mercury take place on the high specific surface area of the carbon. These carbons are often doped or impregnated with further additives (e.g., Cl, Br, I, S) for improved separation of elemental mercury. The production of activated carbons for elemental Hg separation is complex and energy-intensive.

The fourth technology to be mentioned is tetrasulfide addition to the flue gas before the dust precipitation (EP 0 709 128 A2). The elemental mercury is chemically bound in this case and separated as a solid product together with the filter dust. This requires large amounts of precipitant or a fabric filter.

The object of the invention is to find a method for the separation of mercury from power plant exhaust gas (flue gas), wherein the disadvantages of the prior art are eliminated and a simple method is realized to effect optimal oxidation of the mercury present in flue gas.

### SUMMARY

The object is achieved according to the invention as in patent claim 1. Beneficial variations and additions are subject of the dependent claims.

A method has been developed for the oxidation and improved separation of mercury (Hg) from power plant flue gas. The novel method has several aspects:
A powdery, catalytically active material having a mean grain diameter <35 μm is prepared and the mixed material is injected into the flue gas by known injection devices. The injection takes place in the flue gas path after the combustion chamber. The increased formation of oxidized mercury is performed in a temperature range <500° C.
The injected material consists essentially of inorganic and non-combustible material.
The powdery, catalytically active material preferably consists of iron(III) oxide.
The injection device for the introduction of the material into the flue gas is provided downstream of an economizer, downstream of an air preheater or downstream of dedusting.
The powdery, catalytically active material is incurred as a waste product during treatment and remediation processes of waters or even bodies of water and is used procedurally.
The powdery, catalytically active material consists of heavy metal oxides and hydroxides, wherein oxides and hydroxides of iron, copper, manganese, zinc, vanadium, tungsten, cobalt, chromium and nickel are used.

A finely powdered, inorganic, catalytically active material of mean grain diameter d50<35 μm, preferably iron(III) oxide, hereinafter referred to as “material”, is added to the flue gas before or after the air preheater and separated via the dedusting system together with the filter ash. The injection amounts are so small in comparison to the resulting filter dust that the dust's quality and subsequent use are not adversely affected.

Alternatively, an addition to the dedusting system and a separation via devices for flue gas desulfurization are also possible. Homogeneous distribution should be taken into account when adding the catalyst to the flue gas.

The measure proposed here is based on a method according to the invention, which requires little equipment and avoids large-scale plant retrofits. The catalytic material in this case is distributed from a silo by a discharge device and conveying air to different injection lances and is directly introduced into the exhaust gas stream, distributed as homogeneously as possible. Elemental mercury is thereby converted into oxidized form on contact with the iron(III) oxide. The separation of oxidized mercury then takes place in subsequent devices for flue gas treatment, such as the dust removal or desulfurization. The catalytically active material, preferably iron(III) oxide, is separated together with the filter dust at the dedusting system or in the desulfurization system. In contrast to activated carbons which might be used for the same purpose, the catalytically active material is not combustible or explosive, which means that the disclosed method has a significantly lower safety risk.

No additional pressure loss is caused by the devices for flue gas cleaning when using this catalytic method. With the exception of the injection device, no further systems need to be installed in the flue gas path.

The mechanism of the improved Hg separation is based on converting poorly water-soluble elemental Hg species to highly water-soluble and thus much better separable, oxidized mercury species (Hgox). The method uses the halides present in the fuel or flue gas as reactants for elemental Hg. This oxidation reaction proceeds more efficiently at lower temperatures with the addition of the catalyst.

The material used has a high specific surface area (m²/g) and is therefore fundamentally more reactive than oxidatively active constituents occurring natively in filter dust.

A flue gas cleaning device (dedusting or desulfurization) must be present downstream of the injection point for the catalytic material.

The catalytic function of the material is provided both during the flight phase in the flue gas and during the dwell phase in the filter cake of a dedusting system.

As a result of higher Hgox concentrations, the overall degree of separation of Hg increases via downstream devices for flue gas cleaning. Adsorptive separation effects of mercury can also take place directly on the injected material.

Essentially, the method is composed of the following method steps and characteristics:
1. The method is used for oxidation and thus improves the separation of mercury in power plant flue gas with the addition of a powdery, catalytically active material having mean grain diameters <35 μm, preferably iron(III) oxide.
2. The powdery material is injected into the furnace gas by customary injection devices (e.g., screw conveyors, blowers) and separated via existing cleaning devices, for example, an electrostatic filter or an wet flue gas desulfurization.
3. The effect of the material shows up during the flight phase from injection to separation from the flue gas stream.
4. The catalytic effect is enhanced with the formation of a flow-through filter cake.
5. The catalytic effect takes place in the temperature range of <500° C., resulting in suitable injection after an economizer, after an air pre-heater or after a dust filter.
6. The catalytic effect is brought forth by base metals or their oxides. Applications, which implement the use of heavy metal oxides and hydroxides are possible. Those can be: oxides and/or hydroxides of iron, copper, manganese, zinc, vanadium, tungsten, cobalt, chromium and nickel.
7. The material used is essentially inorganic and non-combustible.
8. The method may further be used for the separation of acidic furnace gas components, such as hydrochloric acid (HCl) and sulfur oxides (SO₂, SO,), if metals are added in the form of hydroxides.
9. The separation of the acidic furnace gas components under point 8 is based on adsorption mechanisms.
10. If an adsorption according to point 9 takes place, the injected material acts as a catalyst and adsorbent for mercury and mercury compounds.
11. According to point 10, the mercury separation improves at that stage of the method at which the separation of the catalytically or adsorptively acting material from the flue gas stream takes place.

### BRIEF DESCRIPTION OF THE DRAWINGS

The following figures are referenced in the following detailed explanation: FIG. 1 shows several block diagrams illustrating options of injecting a catalytic material to a flue gas;

FIG. 2 is a table showing results of a first exemplary embodiment of a method for separating mercury from flue gas; and

FIG. 3 is a table showing results of a second exemplary embodiment of a method for separating mercury from flue gas.

### DETAILED DESCRIPTION

As illustrated in FIG. 1, in a lignite combustion power plant the injection 6 of a catalytic material according to the invention takes place downstream of a boiler/combustion 1 and/or an air preheater 2 and/or a dedusting system 3. In this case, the catalytically active material is injected into the furnace gas via known injection devices, such as screw conveyors or blowers. A typical lignite combustion plant comprises the boiler/combustion 1, followed by an air preheater 2, a dedusting system 3, a desulfurization system 4 and a chimney/cooling tower 5.

If the material according to the invention is to be used in a bituminous coal combustion power plant, the injection takes place in the ongoing process downstream the boiler/combustion 1, the air pre-heater 2 and/or the catalytic denitrification 7 and/or the dedusting system 3. After the dedusting system 3, desulfurization 4 takes place towards the chimney/cooling tower 5.

If the method according to the invention is used in sewage sludge or waste incineration, the addition of the material according to the invention is carried out by way of process engineering via the boiler/combustion 1, the air preheater 2, the dedusting system 3. After dedusting 3, the desulfurization 4, the catalytic denitrification 7 takes place towards the chimney/cooling tower 5. Customary injection devices, such as screw conveyors or blowers, are used for the feeding of the produced material into the furnace gas, as already described.

### Example 1

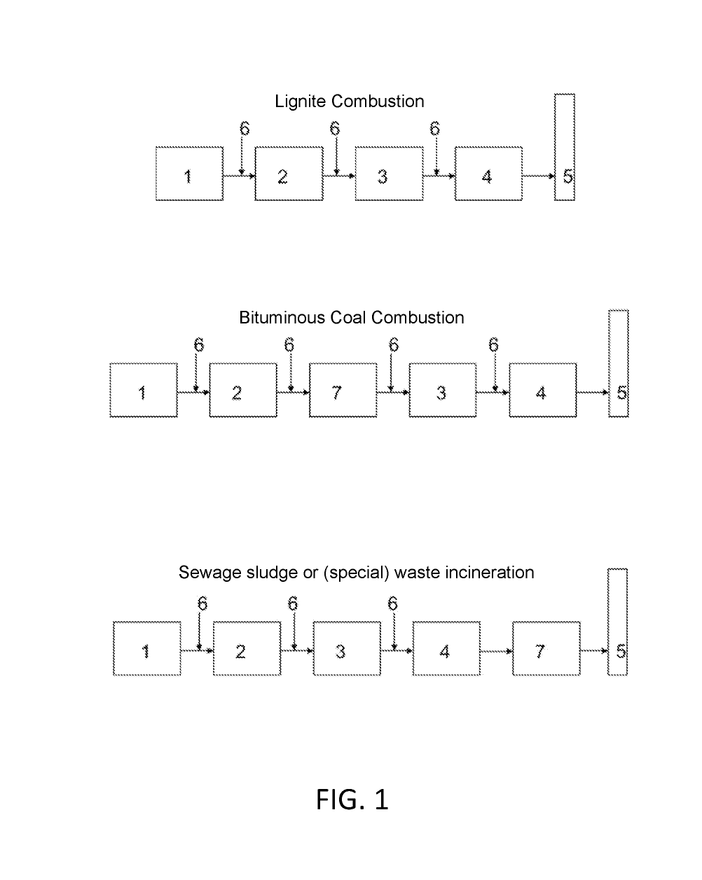

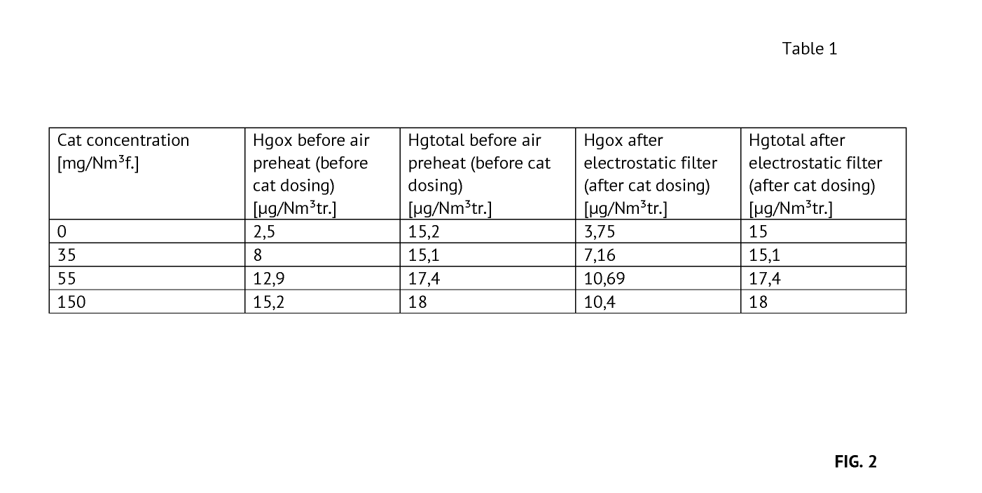

The material, preferably iron(III) oxide, was added to the flue gas of a lignite-fired power plant at temperatures around 320° C. in in front of the air preheater. The feed of the catalyst was carried out via a pneumatic conveyor line from the silo via a lance system having 12 injection points distributed over the cross section of the waste gas duct. The separation of the catalyst was carried out together with the filter dust via electrostatic filter. The mean grain diameter of the iron-containing catalyst was 1.5 μm. Concentrations in the crude gas were adjusted between 35-150 mg/Nm³f and oxidation results achieved are shown in Table 1, FIG. 2.

Without injection of catalyst material, the oxidized Hg content was <4 μg/Nm³tr in the usual range of total Hg inventory of 15 μg/Nm³tr. After electrostatic filter, this results in a proportion of about 25% oxidized Hg. This proportion increased to almost 50% with injection quantities around 35 mg/Nm³f. A proportion of oxidized mercury of 57% was reached with maximum cat concentration of 150 mg/Nm³f.

### Example 2

The material, preferably iron(III) oxide, was added to the flue gas in the lignite-fired power plant after air preheater/before electrostatic filter at temperatures around 170° C. The feed of the catalyst was carried out via a pneumatic conveyor line from the silo via a lance system having 12 injection points distributed over the cross section of the waste gas duct. The separation of the catalyst was carried out together with the filter dust via the subsequent electrostatic filter in the process.

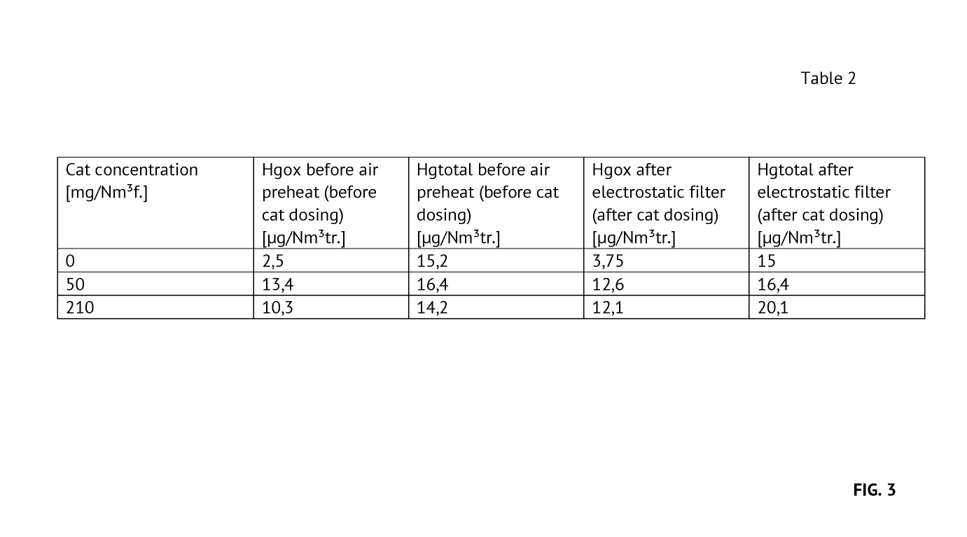

The mean grain diameter of the iron-containing catalyst was 1.5 μm. Concentrations in the crude gas of 50 and 210 mg/Nm³f were tested and the oxidation results achieved are shown in Table 2, FIG. 3.

In the case of a catalyst concentration of 50 mg/Nm³f, a concentration of 12.6 μg/Nm³ of oxidized Hg was determined (approximately 75% proportion oxidized Hg from the Hg inventory). A significant increase in the dose to 200 mg/Nm³ cat material achieved no increase of the oxidized Hg concentration.

### REFERENCE NUMERALS

1. Boiler/combustion
2. Air preheater
3. Dedusting System
4. Desulfurization System
5. Chimney/cooling tower
6. Optional injection point of catalytic material for Hg oxidation
7. Catalytic denitrification

1-6. (canceled)

7. A method for oxidizing and removing mercury from a power plant flue gas, comprising:
preparing a powdery, catalytically active material comprising iron(III) oxide with a mean grain diameter <35 μm;
injecting the material into the flue gas downstream of a combustion chamber, thereby causing an increased formation of oxidized mercury at a temperature range <500° C.; and
removing the oxidized mercury and the powdery, catalytically active material comprising iron(III) oxide from the flue gas in a flue gas cleaning device.

8. The method as in claim 7, wherein the powdery, catalytically active material comprising iron(III) oxide is incurred as a waste product during treatment and remediation processes of waters or bodies of water.
